(19) United States
(12) Patent Application Publication
(10) Pub. No.: US 2023/0038948 A1
(43) Pub. Date: Feb. 9, 2023

(54) INTERMEDIATE DEFORMATION LAYER WITH ADJUSTABLE MACROSCOPIC STIFFNESS FOR BONDED ASSEMBLY

(71) Applicants: ELECTRICITE DE FRANCE, Paris (FR); COLD PAD, Paris (FR)

(72) Inventors: Jean-Philippe COURT, Paris (FR); Hamza ABBAD EL ANDALOUSSI, Issy Les Moulineaux (FR); Firas SAYED AHMAD, Paris (FR); Pierre MONTAUFRAY, Paris (FR); Alexandre MONTEIL, Lyon (FR); Thierry ROURE, Dardilly (FR)

(21) Appl. No.: 17/786,358

(22) PCT Filed: Dec. 15, 2020
(86) PCT No.: PCT/EP2020/086309

§ 371 Date: Jun. 16, 2022

(30) Foreign Application Priority Data
Dec. 17, 2019 (FR) 19 14681

(51) Int. Cl. B32B 3/12; B32B 7/12; B32B 37/00; B32B 5/14; B33Y 80/00

(52) U.S. Cl. CPC B32B 3/12; B32B 7/12; B32B 37/0076; B32B 5/142; B33Y 80/00; B32B 15/092

(57) ABSTRACT

Disclosed is a bonded assembly comprising at least: a first substrate, a second substrate, an intermediate deformation layer secured to the first substrate, the intermediate deformation layer comprising a material in which cavities are provided so that the intermediate deformation layer has a stiffness which is variable along a direction parallel to the intermediate deformation layer, an adhesive between the intermediate layer and the second substrate.

### CROSS-REFERENCE TO RELATED APPLICATIONS

This application is the U.S. national phase of the International Patent Application No. PCT/EP2020/086309 filed Dec. 15, 2020, which claims the benefit of French Patent Application No. 19 14681 filed Dec. 17, 2019, the entire content of which is incorporated herein by reference.

### FIELD

This disclosure relates to techniques for producing bonded assemblies.

It has applications in a wide variety of fields, which include the connection of an element to a substrate (for example a concrete substrate), in particular to a substrate on which no attachment element was originally provided, or the reinforcement of structures that need to be made more resistant in order to repair or to prevent the appearance of structural defects.

### BACKGROUND

In industry and in construction, elements are often fixed or connected to structures (substrates), in particular to load-bearing structures made of concrete or metal, by means of processes known in the state of the art such as anchoring, welding, drilling, and bolting. These techniques have disadvantages. For example, the insertion of screw anchors can be very difficult in reinforced concrete structures when these are highly reinforced (collisions of the drilling tool with the structural steels of the concrete for example). When the structures are metal, welding can be very complex: risk of explosion, deformation due to temperature, need to repaint painted surfaces damaged by the increase in temperature, etc. These attachment techniques are time-consuming for their installation and require preparation time or implementation precautions. In addition, these attachment techniques may also weaken existing structures.

Solutions involving attachment or connection by gluing allow overcoming these disadvantages. However, such attachments or connections by gluing are vulnerable to high mechanical stresses. In addition, when the substrate has been subjected to or is being subjected to mechanical deformations or significant forces, stress concentrations or edge effects appear in particular at the periphery of the adhesive layer, which can damage the attachment or connection.

More generally, the assembly of two substrates bonded by an adhesive may be subjected to external forces, in particular causing differential deformations between the substrates. For this purpose, it is generally customary that the adhesive fulfills at least two functions:
adhering to each of the two substrates (desired primary function), and
absorbing the stresses inherent to differential deformations (secondary function subjected to).

In FIG. 1A, an example of a conventional bonded assembly ACC is illustrated, comprising a first substrate S1 and a second substrate S2 which are made integral by means of a conventional adhesive ADC. Labels A and B are represented at the corners of the adhesive ADC in order to observe (see below) an example of deformation undergone by the adhesive.

Illustrated in FIG. 1B is an example of a sectional view of the bonded assembly ACC when the latter is subjected to deformation forces F (for example opposing forces respectively applied to substrates S1 and S2). The adhesive ADC deforms under the influence of the stresses imposed by the forces F. The most pronounced deformations usually appear at the edges of the adhesive ADC.

In FIG. 1C is represented an example of the evolution in the shear stresses T, inherent to the applied forces F, undergone by the adhesive ADC between the labels A and B. Due to the application of the forces F, the adhesive ADC also undergoes peel stresses u between labels A and B as represented in FIG. 1C.

The differential displacements of the substrates S1 and S2 generate shear and peel stresses which are high in particular in the region of the edges of the adhesive ADC. On the other hand, it should be noted that there is little force, or in some cases none at all, on the adhesive ADC in a central area between labels A and B. The forces are thus mainly transmitted from one substrate to the other via the edge regions.

It is understood that a correlation exists between the deformation of the adhesive ADC observed in FIG. 1B and the stresses undergone by the adhesive as shown in FIG. 1C. This correlation is also known as the “edge effect”. The deformation and therefore the stresses located at the edges of the adhesive significantly impact the integrity of the adhesive ADC in these areas. The bonded assembly ACC is thus vulnerable to the aforementioned differential deformations, which greatly reduces its mechanical capacities, especially when the forces to be conveyed become significant.

The mechanical capacities of the bonded assembly are therefore limited, all the more so when the differential deformations to which the assembly is exposed become high.

This phenomenon also appears when the bonded assembly is intended to reinforce a structure. Indeed, the adhesive may then be subjected to deformations inherent to the movements of the structure to be reinforced.

By way of example, FIGS. 2A to 2C illustrate the first substrate S1 whose role is to reinforce the second substrate S2 which can be a structural panel. It should be noted that when the second substrate S2 is subjected to deformations under stress from forces F for example (typically produced by deformations of the structure), the adhesive absorbs at least some of the differential deformations, generating high shear τ and peel σ stresses at the edges of the adhesive (at and near labels A and B).

To reinforce the mechanical capacities of the bonded assembly, which are limited by these localized stresses, one solution may consist of increasing the adhesion surface area between the adhesive and the substrates, more particularly by extending the length of the surface (i.e. increasing the distance between labels A and B). Indeed, with such an increase in the adhesion surface area between the adhesive and the substrates, the mechanical capacities of the bonded assembly are improved, at least up to a certain limit.

In FIG. 3 is illustrated a graphical representation of the force F necessary to obtain rupture of the adhesive, as a function of the length L of the contact surface area between the adhesive and the substrates (i.e. length between labels A and B). It should be noted that the force F applied at rupture increases linearly up to a limit value Fₘ corresponding to a limit length Lₘₐₓ beyond which the force applied for rupture is substantially identical.

This stabilization of the force F at rupture starting at a certain length of the adhesion surface is largely caused by the edge effects which persist in greatly deforming and stressing the adhesive at its edges, locally weakening the adhesive and causing it to detach from the substrates by adhesive or cohesive failure. A “cascading” rupture is then observed in the adhesive (or in the substrate if this is weaker) which begins at the edges and spreads to the rest of the adhesive.

To limit edge effects, it may be provided to supply a surplus of adhesive material (in the form of a bead of adhesive for example) on either side of the adhesion surface to improve the adhesive strength at the edges. However, the application of excess material may be difficult to achieve in certain configurations, causing uncertainty as to the exact behavior near the edges after the additions of adhesive. In addition, this embodiment is more expensive, requiring additional precautions during installation and/or manufacture. The benefit obtained is also quite limited.

For example, when the adhesive is installed between a structure and a reinforcing element of the structure, the operation of adding excess adhesive should be carried out on site, which may be onerous if not impossible, due to external conditions or to the configuration of the structure.

In addition, it should be noted that the need for an adhesive to provide the abovementioned functions (adhesion to substrates and absorption of deformations) may prove to be incompatible. Indeed, it is generally observed that the more flexible an adhesive (i.e. better absorption capacity), the more reduced its adhesion capacities. Conversely, the stiffest adhesives provide the best adhesion capacities, but are more sensitive to deformation stresses.

### SUMMARY

The disclosure improves at least some elements of the situation described above.

To this end, according to a first aspect, the disclosure relates to a bonded assembly comprising at least:
a first substrate,
a second substrate,
an intermediate deformation layer secured to the first substrate, the intermediate deformation layer comprising a material in which cavities are provided so that the intermediate deformation layer has a stiffness which is variable along a direction parallel to the intermediate deformation layer,
an adhesive between said intermediate layer and the second substrate.

The variable stiffness provides the intermediate layer/adhesive ensemble with capacities for absorbing deformations which may vary parallel to the first substrate. These variations in stiffness make it possible to locally control the level of deformation, and therefore the stresses.

The deformation behavior may in particular be controlled so as to more evenly distribute the shear and peel stresses, which are usually located near the edges of the adhesive (as explained above).

Local deformations are thus effectively absorbed by the intermediate deformation layer, its stiffness (the inverse of flexibility) being controlled, the edges of the adhesive then being less exposed to the stresses generated by external forces applied to the bonded assembly. The edge effects and more generally the stress concentrations in the intermediate deformation layer, in the adhesive, as well as on the surface of the substrates, can be significantly reduced, thereby increasing the strength and integrity capacities of the adhesive, and reinforcing the securing of the substrates and the structural capacities of the bonded assembly. The force required to obtain failure is therefore much higher than in the state of the art. It is understood that the bonded assembly is thus less vulnerable to deformation forces, which are absorbed or distributed along the intermediate deformation layer.

Thus, the object of the disclosure is to maintain good deformability without compromising the adhesive function by selecting stiff adhesives which perform well.

In addition, if one of the two substrates has areas of weakness (crack, weld, etc.) or areas where the substrate is subjected to greater stresses, the deformation behavior of the intermediate deformation layer can be controlled so as to reduce the stresses transmitted between the intermediate deformation layer and the substrate at these areas (for example by reducing the stiffness of the intermediate deformation layer that is facing the weak or highly stressed area).

Control of the deformation behavior, which is carried out by varying the stiffness of the intermediate deformation layer in a direction parallel to said layer, is obtained by means of cavities located in the intermediate deformation layer. For example, the intermediate deformation layer is made of a single material and cavities are provided in the mass of the material forming the intermediate deformation layer. By arranging the cavities in an appropriate manner, for example by adapting the density of the cavities, adapting the size of the cavities, or adapting the shape of the cavities, it is possible to locally adapt the stiffness of the intermediate deformation layer and in particular to vary the stiffness of said layer along a direction parallel to the intermediate deformation layer. Thus, the cavities are configured to give the intermediate deformation layer a stiffness which is variable along a direction parallel to the intermediate deformation layer.

Moreover, as the variation in stiffness is obtained by the presence of cavities, the stiffness (meaning the macroscopic stiffness) and the microscopic stiffness (Young's modulus) are no longer directly dependent on one another. A wider choice of materials can be used to form the intermediate deformation layer CID.

It is thus possible to choose materials with a high Young's modulus value, for example materials with a Young's modulus value of between 1000 and 5000 MPa and advantageously between 2000 and 5000. The CID can thus be formed entirely of a material having such a Young's modulus value. The intermediate deformation layer nevertheless retains good deformation capacities without compromising the adhesive function.

In addition, such materials have better mechanical strength than a material of lower stiffness, in particular with:
a higher breaking strength (for example greater than 10 MPa and advantageously between 30 and 100 MPa),
better creep behavior (allowing the bonded assembly to be subjected to high loads over long periods), and
better relaxation behavior,
   and this holds true at higher temperatures (for example between 50 and 250° C.).

In addition, the value of the Young's modulus of the material can be similar to the value of the Young's modulus of the adhesive. With the adhesive and the material used for the intermediate deformation layer having the same Young's modulus or similar Young's moduli, they have similar mechanical behaviors, which reduces the differences in stiffness between the adhesive and the intermediate deformation layer, resulting in better bonding of the adhesive to the intermediate deformation layer.

It is also possible to choose materials with good adhesive affinities with the adhesive, making it possible to ensure better bonding between the intermediate deformation layer and the adhesive. Adhesive affinity is understood to mean good compatibility between two materials, resulting in good mechanical strength and, in the ultimate state, cohesive failure, meaning a rupture of one of the two materials involved (CID, Adhesive) and not a rupture at the interface between the adhesive and the CID.

Shape of the cavities is understood to mean the geometry thereof; the cavities form microstructures within the intermediate deformation layer.

Density of cavities or density of microstructures is understood to mean the number of cavities or microstructures per unit area or unit volume of the intermediate deformation layer.

Cavity is understood to mean that the intermediate deformation layer comprises holes. The holes can leave room for residual elements which form microstructures.

Stiffness which is variable along a direction parallel to the intermediate deformation layer is understood here to mean that the stiffness varies along the substrate, meaning that the stiffness of the intermediate deformation layer (CID) at points located in a (possibly planar) surface substantially parallel to the CID varies within this surface. The parallel surfaces considered are for example all the surfaces comprised between the two faces of the CID and parallel to one of them. In other words, the stiffness is variable from one portion of the intermediate deformation layer to another portion, the two portions being distributed longitudinally.

Stiffness is understood to mean the stiffness in one or more directions, for example the stiffness in a direction of vector(z) at the intermediate deformation layer or the stiffness in a direction parallel to the intermediate deformation layer, for example the direction of vector(x) or vector(y), or even in a linear combination of vector(x) and vector(y) ((vector(x), vector(y), vector(z)) forming a spatial reference system and (vector(x), vector(y)) forming a reference system for the surface parallel to the intermediate deformation layer, vector(z) possibly being orthogonal to reference system (vector(x), vector(y)), with vector(u) being the designating notation). The stiffness at a point (x, y) of the surface parallel to the CID can be represented by the triplet (R_{vector(x)}(x,y); R_{vector(y)}(x,y); R_{vector(z)}(x,y)), where R_{vector(x)}(x,y) represents the value of the stiffness in the direction of vector (x) at point (x,y), R_{vector(y)}(x,y) represents the value of the stiffness in the direction of vector (y) at point (x,y), and R_{vector(z)}(x,y) represents the value at point (x,y) of the stiffness in the direction of vector (z) which is possibly orthogonal to the intermediate deformation layer.

The stiffness which is variable along a direction parallel to the intermediate deformation layer may for example concern stiffness R_{vector(z)}(x,y) along the direction of vector(z) at the intermediate deformation layer, which is variable, and/or stiffnesses R_{vector(x)}(x,y) and/or R_{vector(y)}(x,y) along the directions parallel to the intermediate deformation layer.

The edge effects are particularly attenuated when the stiffness R_{vector(z)}(x,y) is reduced along the direction of vector(z) (which may be orthogonal to the intermediate deformation layer) at the edges of the intermediate deformation layer.

The forces on the areas weakened or subjected to significant stresses are particularly attenuated when the stiffness of the intermediate deformation layer which is facing the areas along the same direction as those of the forces generating these forces is reduced.

Secured is understood to mean that the substrate and the intermediate deformation layer are joined to each other so as to form an inseparable whole; this may be obtained with adhesives, but it is also possible to form the intermediate deformation layer directly on the substrate with which it becomes integral.

According to one embodiment, a first face of the intermediate deformation layer and/or a second face of the intermediate deformation layer respectively have shapes complementary to the surface of the first substrate and/or to the second substrate.

This makes it possible to have improved adhesion between the surfaces of the intermediate deformation layer and the substrates. Indeed, as the surfaces of the intermediate deformation layer are complementary to the surfaces of the substrates, the intermediate deformation layer fits more closely against the surfaces of the substrates, creating a uniform and almost constant thickness of the adhesive layer, between the intermediate deformation layer and the substrates.

The microstructures formed by the cavities may be elements of elongated shape connecting the two faces of the intermediate deformation layer.

The intermediate deformation layer may thus comprise two outer layers forming the two faces of the intermediate deformation layer. The elongated elements connect the two outer layers. The ensemble of the two outer layers and the elongated elements thus forms the intermediate deformation layer. The elongated elements form spacers between the two outer layers.

The elongated elements may have constant or variable cross-sections and the cross-sections may be circular, triangular, rectangular, or any other shape. The outer layers which are made of the material of the intermediate deformation layer may be continuous, in order to adhere more strongly to each substrate.

The use of elongated shapes makes it possible to create a structure having the desired mechanical properties, namely that the intermediate deformation layer has a stiffness along at least one direction which is adapted and varies in a direction parallel to the intermediate deformation layer.

To achieve this, the stiffness of the intermediate deformation layer in one direction may be adapted by adapting the cross-sections of the elongated elements and/or the spacings between the elongated elements and/or the directions of the elongated elements. The stiffness in one direction can be increased by orienting the elongated elements in this same direction.

Adaptation of the elongated elements makes it possible to adapt the stiffness in one direction independently of the level of stiffness in another direction. It is thus possible to configure the elongated elements so as to have, at the same point of the intermediate deformation layer, a high stiffness in one direction and a low stiffness in another direction.

The elongated elements may form a lattice or mesh structure.

A lattice structure makes it possible in particular to adapt the stiffness according to the direction. Thus, it is easier in a lattice structure to adapt a stiffness to be low along one direction and to maintain a high stiffness along another direction (for example a low R_{vector(z)} value and a high R_{vector(x)} value).

The elongated elements may be aligned in a direction orthogonal to the intermediate deformation layer, for example in a comb arrangement.

Such a structure of the intermediate deformation layer makes it possible to adapt the stiffness R_{vector(z)} along the direction orthogonal to the intermediate deformation layer while maintaining low stiffness along the direction parallel to the intermediate deformation layer. Indeed, the stiffness R_{vector(z)} along the orthogonal direction can easily be reduced (respectively increased), for example by reducing (respectively increasing) the cross-section of the elongated elements or by spacing apart (respectively placing closer together) the elongated elements.

According to one embodiment, the cavities provided are not compartmentalized from each other.

Not compartmentalized is understood to mean that the cavities do not form a compartment and are therefore open. The flow of fluid is thus made possible between the cavities of the intermediate deformation layer and the exterior of the intermediate deformation layer, at least before it is secured to the first and second substrates. This makes it possible, when photopolymerization-type 3D printing techniques are used to manufacture the intermediate deformation layer, to drain the unpolymerized liquid polymer contained in the intermediate deformation layer when the printing ends.

According to one embodiment, the intermediate deformation layer is formed of a material that is homogeneous in composition.

This homogeneous material characteristic allows more precise and better controlled adjustment of the stiffness of the CID by means of the cavities (for example microstructures). Advantageously, a homogeneous material will be chosen which may, for example, be of the type:

The material may be:
an epoxide;
an elastomer;
a plastic;
polyurethane;
a composite;
a metal.

More generally, one can use any material having good adhesive affinity with the adhesives used. In the event of insufficient adhesive affinity, an adhesion primer or an interface layer may be used between the intermediate deformation layer and the adhesive.

According to one embodiment, the first substrate is a reinforcement piece 15 suitable for reinforcing the second substrate. Reinforcement piece is understood to mean a piece providing structural and/or mechanical reinforcement of the second substrate.

According to one embodiment, the first substrate is secured to an attachment means. For example, a mechanical connector is secured to the substrate (it may for example be glued to it).

According to one embodiment, the stiffness of the intermediate layer varies gradually. This makes it possible to reduce the stress concentrations which appear at areas where the stiffness transitions are too abrupt within the area concerned, involving the adhesive, intermediate deformation layer, and substrate all at the same time. Indeed, in these transition areas, phenomena similar to those of edge effects appear between the portions of high stiffness and the portions of low stiffness. In addition, this ensures good control of the deformation and absorption behavior of the intermediate deformation layer, along its entire length.

According to one embodiment, the intermediate layer comprises a portion arranged at the edge of the intermediate layer and having a lower stiffness along one direction than the stiffness in said direction of another portion of the intermediate layer. This means the stiffness of the intermediate deformation layer is lower at the periphery of the intermediate deformation layer. This lower stiffness at the periphery or in the portion arranged at the edge of the intermediate deformation layer is obtained by means of cavities arranged appropriately in the intermediate deformation layer: for example, by increasing the density of the cavities at the periphery or in the portion arranged at the edge. It is also possible to obtain a lower stiffness in these same portions of the intermediate deformation layer by increasing the size of the cavities or by adapting the shape of the cavities. This makes it possible to reduce edge effects. The shape of the edge may also be adapted in order to gradually reduce the stiffness at the periphery of the intermediate deformation layer, for example with a bevelled or beak-shaped edge of the intermediate deformation layer. The peripheral stiffness may be reduced for all directions (R_{vector(x)}, R_{vector(y)}, R_{vector(z)}) or primarily in one direction. When the forces exerted on one of the two substrates or on both substrates follow a specific direction then it may be advantageous in order to reduce edge effects to reduce the stiffness along this direction (primarily a direction orthogonal to the intermediate deformation layer or a longitudinal direction). For example, it is advantageous to reduce stiffness R_{vector(z)} along a direction of vector(z) (which may be orthogonal or primarily orthogonal to the intermediate deformation layer) when the bonded assembly is primarily loaded in tension. The stiffness may optionally be reduced locally at the exact location where the tensile force is applied.

“Portion of the intermediate deformation layer” is understood to mean a localized portion of the intermediate deformation layer to which a desired level of stiffness has been assigned during manufacture.

Periphery of the intermediate deformation layer, or equivalently the edge of the intermediate deformation layer, is understood to mean the peripheral area of the intermediate deformation layer.

The portion arranged at the edge may be for example the portion of the intermediate deformation layer located at a distance less than a threshold (for example 10 mm) from the edge; the other portion of the intermediate deformation layer being for example a portion located at a distance greater than the threshold from the edge.

According to one embodiment, the intermediate deformation layer comprises a portion covering an area of weakness of the second substrate and/or a crack in the second substrate, said portion of the intermediate deformation layer having a lower stiffness along one direction than the stiffness along said direction of another portion of the intermediate deformation layer. Meaning that the stiffness of the intermediate deformation layer is lower at the portion covering the area of weakness or the crack. This lower stiffness of the intermediate deformation layer at the portion of the intermediate deformation layer covering the area of weakness or the crack is obtained by means of cavities arranged appropriately in the intermediate deformation layer. For example, by increasing the density of the cavities in the intermediate deformation layer at the portion covering the area of weakness or the crack at the periphery or in the portion arranged at the edge. It is also possible to obtain a lower stiffness in this same portion of the intermediate deformation layer by increasing the size of the cavities or by adapting the shape of the cavities. The forces on the areas weakened or subjected to significant stresses are thus particularly attenuated. The stiffness of this portion may be reduced for all directions (R_{vector(x)}, R_{vector(y)}, R_{vector(z)}) or primarily along one direction. When the forces exerted on one of the two substrates or on both substrates follow a specific direction, then it may be advantageous to reduce the stiffness along this direction (primarily a direction orthogonal to the intermediate deformation layer or a longitudinal direction). For example, it is advantageous to reduce stiffness R_{vector(z)} along a direction of vector(z) (which may be orthogonal or primarily orthogonal to the intermediate deformation layer) when the bonded assembly is primarily loaded in tension (in particular reducing the stiffness at the exact location where the force is applied).

Area of weakness of the substrate or area of high stress of the substrate is understood to mean any area where there is a chance of rupture or cracking of the substrate, either because of its structure or because of the forces applied to it.

According to one embodiment, the mechanical resistance of the intermediate deformation layer to tensile stress and/or to shear stress is lower than the mechanical resistance of at least one among the first substrate and second substrate. This strength may be determined in a preliminary step.

Mechanical resistance of the intermediate deformation layer to tensile stress and to shear stress is understood to mean the total ultimate resistance along the vertical axis Z or the horizontal plane X, Y, or else a combination of the two.

This makes it possible to avoid rupture of the substrate. Indeed, when significant stresses are transmitted from the first substrate to the second substrate via the intermediate deformation layer, these stresses will first cause rupture of the intermediate deformation layer before rupture of the substrate, thus preserving the substrate.

Advantageously, a gap between the substrates comprises a gasket around the intermediate layer, arranged so as to be compressed by the substrates held relative to each other by the adhesive.

The compressed gasket makes it possible to isolate the intermediate layer/adhesive ensemble from the medium which surrounds the bonded assembly. This isolation ensured by the gasket preserves this ensemble under conditions of use which allow ensuring good durability. It is thus possible to choose the material of the intermediate layer and of the adhesive according to the desired properties and the compositions of the substrates to be held relative to each other, while being confident that these properties are obtained in an effective and lasting manner.

According to a second aspect, the disclosure relates to a method for manufacturing an element of a bonded assembly, the method comprising:
the formation of an intermediate deformation layer comprising a material, said formation of the intermediate deformation layer being carried out so as to obtain cavities in the material such that the intermediate deformation layer has a stiffness which is variable along a direction parallel to the intermediate deformation layer;
securing together the formed intermediate layer and a first substrate.

According to one embodiment, the intermediate deformation layer is formed on a support consisting of one of the aforementioned substrates.

According to one embodiment, the formation of the intermediate layer is carried out by an additive manufacturing technique.

Additive manufacturing technique is understood to mean the techniques defined as such by the ASTM. Additive manufacturing is also called 3D printing.

This makes it possible to obtain a high level of precision in the manufacture of the microstructures and their positioning, thus making it possible to precisely control the stiffness of the intermediate deformation layer and its variation within the intermediate deformation layer.

The additive manufacturing techniques that may be used in particular are:
photopolymerization,
powder bed fusion,
binder jetting,
extrusion of materials (example: FDM),
material jetting (example: MJ, NPF, DOD),
sheet lamination (example: LOM, SL),
concentrated energy deposition (example: DED, LENS, EBAM).

According to one embodiment, the method further comprises:
the obtaining of data relating to a shape of a surface of the second substrate; wherein the formation of the intermediate deformation layer is carried out so as to obtain a surface of the intermediate deformation layer having a shape complementary to the shape of the surface of the second substrate.

The data relating to a shape of a surface of the substrate characterize the surface of the substrate and more precisely its contours. Obtaining a surface of the CID having a shape complementary to the shape of the surface of the second substrate is achieved by means of these data relating to the shape of the surface of the second substrate.

According to a third aspect, the disclosure relates to a method for manufacturing a bonded assembly comprising the manufacturing of an element of a bonded assembly according to one of the methods as described above, the method further comprising the bonding of the intermediate deformation layer to the second substrate by means of an adhesive.

According to one embodiment, the bonding of the intermediate deformation layer to the second substrate by means of the adhesive is carried out so that said surface of the intermediate deformation layer is secured to the surface of the second substrate in a complementary manner.

According to a fourth aspect, the disclosure relates to a method for reinforcing a structure comprising at least one substrate to be reinforced, the method comprising:
securing together a reinforcing substrate and an intermediate layer comprising a material in which cavities are provided such that the intermediate deformation layer has a stiffness which is variable along a direction parallel to the intermediate deformation layer,
holding the reinforcing substrate and the intermediate deformation layer on the substrate to be reinforced, by means of an adhesive.

### BRIEF DESCRIPTION OF THE DRAWINGS

Other features and advantages of the disclosure will become apparent upon examining the detailed description below and the appended drawings, in which:

FIGS. 1A-1C illustrate examples of typical embodiments of a bonded assembly, and show the deformations and shear stresses conventionally undergone by the adhesive, in particular at its edges.

FIGS. 2A-2C illustrate examples of embodiments of a reinforcing element bonded to a structure, generating deformations and stresses similar to the examples of FIGS. 1A to 1C.

FIG. 3 represents the evolution, as a function of the overlapping length of two substrates of the adhesion interface of the adhesive, of the ultimate force to be applied in order to obtain rupture of the adhesive in a conventional bonded assembly.

FIGS. 4A-4B illustrate examples of a bonded assembly according to the disclosure.

FIGS. 5A-5G illustrate examples of the intermediate deformation layer according to the disclosure.

FIG. 6 illustrates a method for manufacturing a bonded assembly AC according to the disclosure.

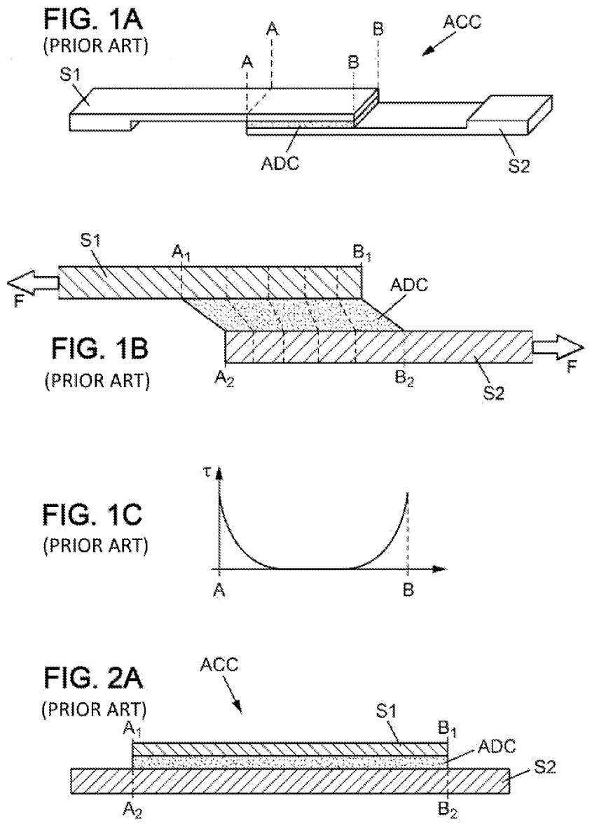

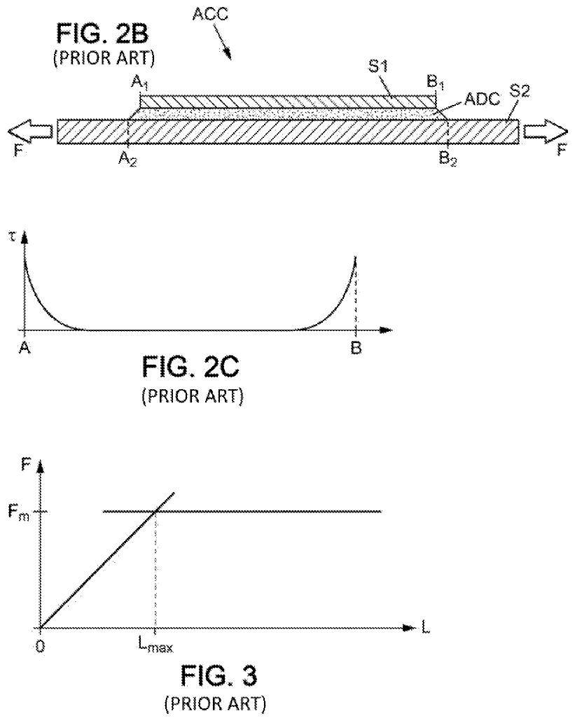

### DETAILED DESCRIPTION

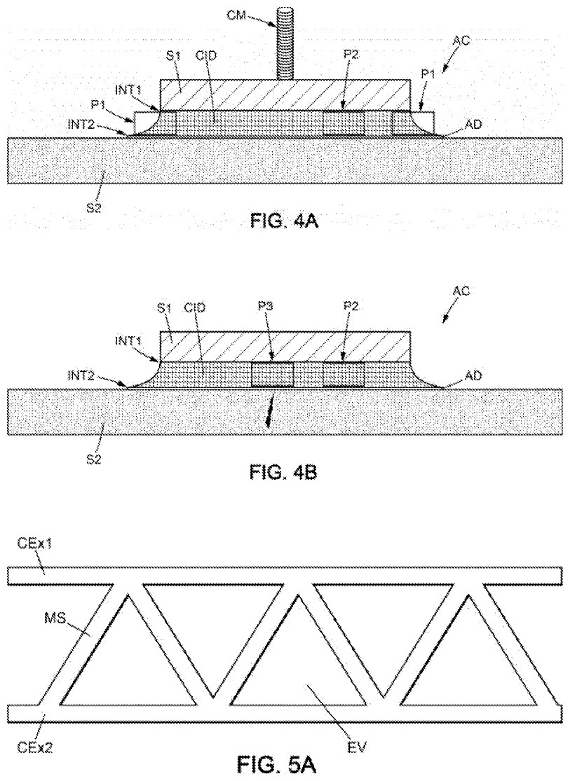

We now refer to FIGS. 4A and 4B in which are illustrated examples of a bonded assembly AC according to the disclosure. The assembly includes a first substrate S1 and a second substrate S2.

In the example shown in FIG. 4A, a mechanical connector (CM) is secured to the first substrate S1; the second substrate may be a wall. Once the first substrate (S1) has been fixed to the second substrate (S2), the bonded assembly (AC) forms an attachment means on the wall.

In the example represented in FIG. 4B, the first substrate S1 is a reinforcing element intended to repair, protect, and/or reinforce a structure comprising the second substrate S2. The reinforcing element may take the form of a rigid plate superimposed on a wall of the structure, typically a plate made of metal, composite, or any other material of sufficient rigidity to reinforce the structure. This reinforcement may be used in particular to reinforce:
concrete structures in seismic zones which can cause cracks that are millimetric in magnitude;
metal structures undergoing significant cyclic loads;
metal or concrete structures undergoing instantaneous or long-term deformations (shrinkage, damage, creep, corrosion).

The assembly AC comprises an intermediate deformation layer, CID, called “deformation”, and an adhesive AD. The adhesive AD is placed between substrates S1 and S2 and is intended to secure them to one another via the CID. The CID comprises a first securing interface INT1 with the substrate S1, and a second securing interface INT2 with the adhesive AD. The CID has variable stiffness along interfaces INT1 and INT2.

The CID and the adhesive AD may be made from the same material. The CID may in particular have a Young's modulus close to that of the adhesive AD.

The material used for the CID may in particular be selected among the following list of polymers:
an epoxide;
an elastomer;
a plastic;
polyurethane; or
a composite.

The use of epoxy and/or polyurethane proves to be particularly effective. Indeed, the adhesive affinities between the CID and the adhesive AD are then improved.

The stiffness R_{vector(v)}(x₁,y₁) of the CID at a point (x₁;y₁) thereof along vector(v) expresses the proportionality relationship between the force F applied at that point and along the same direction as vector(v) and the resulting deflection at that point. When the vector(v) is perpendicular to the CID we use the term tension-compression stiffness; when the vector(v) is parallel to the CID we use the term shear stiffness. This is expressed in newtons per meter (N/m).

The adhesive AD may be relatively rigid and has good capacities for adhesion:
with the substrate S2, due to its rigidity; and
with the CID because of the adhesive affinities of their material and possibly because of the Young's modulus of the CID which may be similar to that of the adhesive AD.

The intermediate deformation layer CID makes it possible to improve:
the absorption of differential deformations at the periphery of the adhesive layer AD (by means of the CID); and
the general adhesion capacities at the interfaces INT1 and INT2 with the substrates via the adhesive AD in which the stresses are distributed more evenly.

In this case, the CID of variable stiffness makes it possible to obtain a controlled behavior which more evenly distributes the shear and peel stresses generated by external forces applied to the bonded assembly AC.

The deformation absorption behavior of the CID makes it possible to reduce or even eliminate the edge effects which usually occur at the adhesive AD in the prior art.

The desired value of the stiffness of the CID along one direction and the variation in stiffness along the CID are obtained via cavities within the layer, as specified above. Thus, to reduce stiffness R_{vector(v)}(x₁,y₁) at point (x₁,y₁) it is possible for example to:
reduce the number and/or the cross-section of the microstructures (elongated elements) oriented along the direction of vector(v); and/or
increase the density of the cavities around point (x₁,y₁); and/or
orient the elongated elements advantageously.

Examples of CIDs with different microstructures are presented below.

In the case of FIG. 4A, a portion P1 arranged at the edge of the CID is represented. This portion of the CID has a lower stiffness level than that of the portion P2 arranged in a central part of the CID. Portion P1 may be for example the peripheral part of the CID, namely the part representing the 20% of the CID at the edge in the longitudinal direction. More specifically, edge effects are greatly reduced when reducing, in P1:
the stiffness in a direction perpendicular to the CID (vector(v)=vector(z)) in order to reduce the edge effects relating to peel stresses; and/or
the stiffness, in the vicinity of a point on the edge, along a direction perpendicular to the edge at this point of the CID and parallel to the plane of the CID (i.e. the radial direction from the edge in the plane of the CID, vector(v)=vector(r) for a polar reference system of the CID when it is a disk) to reduce the edge effects relating to shear.

Because the edge effects are reduced (limit length Lₘₐₓ is substantially increased), the breaking strength of the CID is improved.

In the case of FIG. 4B, a portion P3 is shown arranged at an area of weakness of the CID, namely a crack in the wall. Portion P3 of the CID has a lower stiffness level than that of portion P2.

More specifically, the transfer of stresses between the first substrate (S1) and the second substrate (S2) in the vicinity of the crack is greatly reduced when the stiffness in P3 is reduced along the direction(s) in which the stresses are applied at P3 (namely along the direction perpendicular to the CID if the stresses are peel stresses and/or along one or more longitudinal directions if the stresses are shear stresses).

Although the example of FIG. 4A concerns a mechanical connector and that of FIG. 4B concerns a reinforcement, the CID described in FIG. 4A may also comprise a portion P3 as described in FIG. 4B when the second substrate (S2) has areas of weakness. Similarly, the CID described in FIG. 4B may also comprise a portion P1 as described in FIG. 4A when the bonded assembly (AC) is subjected to high stresses leading to edge effects.

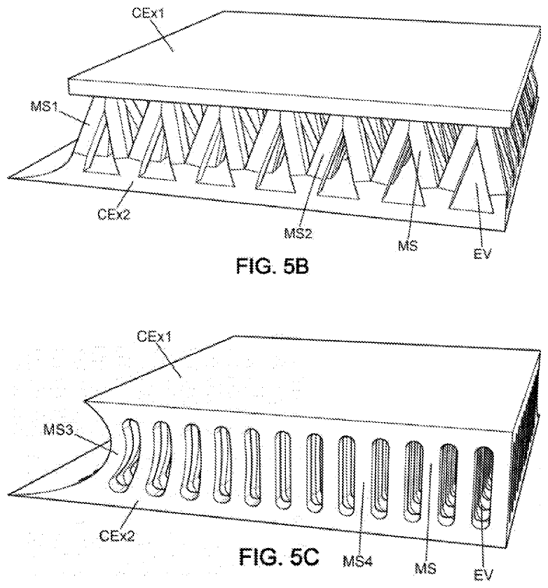

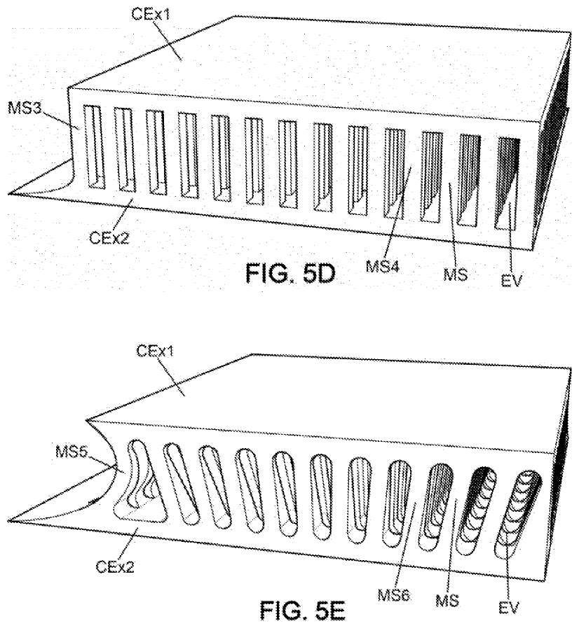

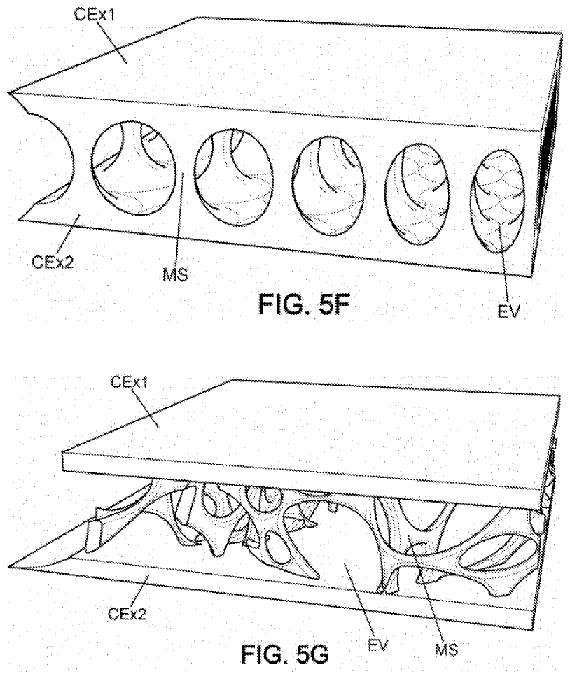

Reference is now made to FIGS. 5A to 5G in which embodiments of the intermediate deformation layer (CID) of variable stiffness have been represented. All of these CIDs can be used in the embodiment of FIG. 4A as well as in that of FIG. 4B. FIG. 5A is a cross-sectional view of the CID shown in FIG. 5B.

The CID comprises a first outer layer CEx1 which is secured to the first substrate S1, and a second layer CEx2 which is secured to the second substrate S2 via the adhesive AD.

Microstructures, MS, connect the two outer layers CEx1 and CEx2. The MS form spacers between the two outer layers CEx1 and CEx2. The cavities, EV, are the spaces not occupied by the MS between CEx1 and CEx2 of the CID. Each CID, and in particular its stiffness and the variation thereof within the plane of the CID, are characterized by the material used to form the CID and the structure formed by the MS or, equivalently, the structure formed by the cavities.

The MS of FIGS. 5A and 5B are elongated elements of rectangular cross-section. The MS form a lattice. The stiffness of the CID can be adapted to obtain the desired properties as described in FIGS. 4A and 4B. For example, to reduce the stiffness at the edge of the CID in all directions:
the MS at the edge of the layer, for example MS1, can have a smaller cross-section than the MS at the heart of the CID, for example MS2;
it is possible to have fewer MS at the edge of the CID.

To reduce the stiffness in the direction orthogonal to the CID at the edge of the CID and increase the stiffness in a direction parallel to the CID, it is possible to:
reduce the angle of inclination of the MS at the edge of the CID relative to CEx1 and CEx2.

Conversely, when the angle of inclination of the MS at the edge of the CID relative to CEx1 and CEx2 is increased, the stiffness in the direction orthogonal to the CID is increased at the edge of the CID and the stiffness in a direction parallel to the CID is reduced. More generally, when the MS are modified inversely to what is described above, an inverse modification of the stiffness is obtained.

The MS which are not located at the edge of the CID, for example MS2, can also be adapted in the same manner to vary the stiffness, in particular in the case where the second substrate S2 has areas of weakness, for example at MS2.

Such a lattice structure of the MS makes it possible to adapt the stiffness along the direction orthogonal to the CID and the stiffness along a direction parallel to the CID without relative constraints between them.

The MS of FIGS. 5C and 5D are elongated elements of rectangular cross-section. The MSs are substantially aligned in the direction orthogonal to the CID. The stiffness of the CID can be adapted to obtain the desired properties as described in FIGS. 4A and 4B. For example, to reduce the stiffness at the edge of the CID in all directions:
the MS at the edge of the layer, for example MS3, can have a smaller cross-section than the MS at the heart of the CID, for example MS4;
it is possible to have fewer MS at the edge of the CID.

In the case of FIG. 5C, it is also possible to reduce the stiffness along the direction orthogonal to the CID at the edge of the CID by modifying the shape of the MSs at the edge of the CID, for example by increasing the curvature of the MS.

When the MS are modified in an inverse manner to what is described above, an inverse modification of the stiffness is obtained.

The MS which are not located at the edge of the CID, for example MS4, can also be adapted in the same manner to vary the stiffness, in particular in the case where the second substrate S2 has areas of weakness, for example at MS4.

Such a structure where the MS are aligned in the direction orthogonal to the CID makes it possible to obtain a high stiffness along this same direction, while allowing the stiffness to be varied along the CID.

The MS of FIG. 5E are elongated elements of rectangular cross-section. The embodiment of FIG. 5E combines MS substantially aligned in the direction orthogonal to the CID and MS that are inclined relative to CEx1 and CEx2. The stiffness of the CID in FIG. 5E can be adapted to achieve the desired properties, as depicted in FIGS. 4A and 4B.

For example, to reduce the stiffness at the edge of the CID in all directions:
the MS at the edge of the layer, for example MS5, can have a smaller cross-section than the MS at the heart of the CID, for example MS6;
it is possible to have fewer MS at the edge of the CID.

To reduce the stiffness along the direction orthogonal to the CID at the edge of the CID and increase the stiffness along a direction parallel to the CID, it is possible to:
reduce the angle of inclination of the MS at the edge of the CID relative to CEx1 and CEx2.

It is also possible to reduce the stiffness along the direction orthogonal to the CID at the edge of the CID by modifying the shape of the MS at the edge of the CID, for example by increasing the curvature of the MS.

When the MS are modified in an inverse manner to what is described above, an inverse modification of the stiffness is obtained.

The MS which are not located at the edge of the CID, for example MS6, can also be adapted in the same manner to vary the stiffness, in particular in the case where the second substrate S2 has areas of weakness, for example at MS6.

Such a structure with MS for which the inclination varies greatly relative to CEx1 and CEx2 makes it possible to obtain stiffnesses of the CID along the orthogonal direction and along the directions parallel to the CID which vary greatly and independently of each other.

The embodiment of FIG. 5F is an alternative to the embodiment of FIG. 5D, where the MS are elongated elements aligned in the direction orthogonal to the CID. However, here the MS are of circular cross-section.

In the embodiment of FIG. 5G, the MSs are free-form, allowing great adaptability of the stiffness within the CID. These free forms may be obtained by numerical simulation.

In addition, it is possible to provide a crack in P3, i.e. the portion of the CID which is facing the area of weakness. This makes it possible to reduce the forces imposed by the possible appearance of a crack in the second substrate S2.

The thickness of the CID is for example between 2 and 20 mm. The material of the CID, namely CEx1 and CEx2 as well as the MS, are of a material homogeneous in composition with a Young's modulus value that is between 1000 and 5000 MPa. The CID may be of the same material as the adhesive or may have a Young's modulus comparable to that of the adhesive AD. This stiffness homogeneity between the CID and the adhesive ensures good adhesion conditions between the CID and the adhesive AD.

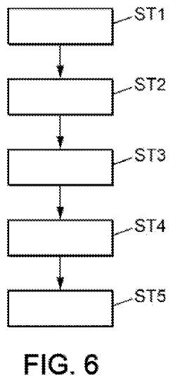

In FIG. 6 a method for manufacturing a bonded assembly AC as described above is illustrated.

In a first step ST1, data relating to the shape of the surface of the second substrate are obtained. For example, the second substrate S2 is scanned by means of a 3D laser scanner or structured-light scanner, or by photogrammetry.

In a second step ST2, the CID is formed. Its stiffness is obtained by an appropriate arrangement of the MS as described above.

The CID may in particular be formed by an additive manufacturing technique, for example by photopolymerization. Since the cavities do not form an enclosure, it is possible to extract the unsolidified polymer.

On the basis of the data obtained in step ST1, CEx2 is formed so that its surface forming the outer face of the CID is complementary to the second substrate S2.

In a third step ST3, the CID is secured (for example by means of an adhesive) to the first substrate (this securing may be carried out in the factory). This step is not performed when the CID is formed directly on the first substrate.

In a fourth step ST4, the assembly formed by the CID and the first substrate S1 is bonded to the second substrate S2 by means of the adhesive AD. The second substrate S2 is prepared for this beforehand (cleaning, surface finishing, etc.). A knob of adhesive is placed on the CID, more precisely on the securing interface INT2. The CID is then positioned facing the second substrate S2 so that the surfaces face each other in a complementary manner. The assembly composed of the first substrate S1, the CID, and the knob of adhesive is transposed onto the second substrate S2 and held in position during the application time.

In a fifth step ST5, in the case where the bonded assembly AC forms an attachment means on the wall, a device may be fixed to the bonded assembly AC via the mechanical connector, for example by bolting.

One will note that the applications for the bonded assembly AC according to the disclosure are not limited to the embodiment described above, and can also serve for:
repairing a structural area that is damaged (typically by corrosion);
repairing a pipeline;
repairing, reinforcing, and/or connecting to industrial structures, aircraft, ships, vehicles, or other.

Of course, the disclosure is not limited to the embodiments described above by way of example and they extend to other variants. In this respect, according to another embodiment, the layers comprised in the intermediate deformation layer may have, for example, a beveled profile in which air cells are also provided. Such an implementation of the bonded assembly may make it possible in particular to refine control of the deformation behavior of the adhesive, in particular at the edges.

1: A bonded assembly comprising at least:
a first substrate,
a second substrate,
an intermediate deformation layer secured to the first substrate, the intermediate deformation layer comprising a material in which cavities not compartmentalized from each other are provided so that the intermediate deformation layer has a stiffness which is variable along a direction parallel to the intermediate deformation layer,
an adhesive between said intermediate layer and the second substrate.

2: The bonded assembly according to claim 1, wherein one or more of a first face of the intermediate deformation layer or a second face of the intermediate deformation layer respectively have shapes complementary to the first substrate and/or to the second substrate.

3: The bonded assembly according to claim 1, wherein the intermediate deformation layer comprises elements of elongated shape connecting two faces of the intermediate deformation layer.

4: The bonded assembly according to claim 3, wherein the elongated elements form a lattice structure.

5: The bonded assembly according to claim 3, wherein the elongated elements are aligned in a direction orthogonal to the intermediate deformation layer.

6: The bonded assembly according to claim 3, wherein the stiffness of the intermediate deformation layer along one direction is adapted by adapting cross-sections of the elements and/or spacings between the elements and/or directions of the elements.

7: The bonded assembly according to claim 1, wherein the material has the same Young's modulus value as the Young's modulus value of the adhesive.

8: The bonded assembly according to claim 1, wherein the stiffness of the intermediate layer varies gradually.

9: The bonded assembly according to claim 1, wherein the intermediate layer comprises a portion arranged at the edge of the intermediate layer and having a lower stiffness along one direction than the stiffness along said direction of another portion of the intermediate layer.

10: The bonded assembly according to claim 1, wherein the intermediate deformation layer comprises a portion covering one or more of an area of weakness of the second substrate, a crack in the second substrate, or an area of high stress, said portion of the intermediate deformation layer having a lower stiffness along one direction than the stiffness along said direction of another portion of the intermediate deformation layer.

11: The bonded assembly according to claim 1, wherein one or more of a mechanical resistance of the intermediate deformation layer to tensile stress or a mechanical resistance of the intermediate deformation layer to shear stress is lower than the mechanical resistance of at least one of the first substrate or the second substrate.

12: The bonded assembly according to claim 1, wherein the intermediate deformation layer is formed of a material that is homogeneous in composition.

13: A method for manufacturing an element of a bonded assembly, the method comprising:
the formation of an intermediate deformation layer comprising a material, said formation being carried out so as to obtain cavities in the material such that the intermediate deformation layer has a stiffness which is variable along a direction parallel to the intermediate deformation layer;
securing together the formed intermediate layer and a first substrate.

14: The manufacturing method according to claim 13, wherein the formation of the intermediate layer is carried out by an additive manufacturing technique.

15: The manufacturing method according to claim 13, the method further comprising:
the obtaining of data relating to a shape of a surface of a second substrate;
wherein the formation of the intermediate deformation layer is carried out so as to obtain a surface of the intermediate deformation layer having a shape complementary to the shape of the surface of the second substrate.

16: A method for manufacturing a bonded assembly, comprising:
the manufacturing of an element of a bonded assembly, according to claim 13, the method further comprising the bonding of the intermediate deformation layer to a second substrate by means of an adhesive.

17: The manufacturing method according to claim 19, wherein the bonding of the intermediate deformation layer to the second substrate by means of the adhesive is carried out so that said surface of the intermediate deformation layer is secured to the surface of the second substrate in a complementary manner.

18: A method for reinforcing a structure comprising at least one substrate to be reinforced, the method comprising:
securing together a reinforcing substrate and an intermediate layer comprising a material in which cavities not compartmentalized from each other are provided such that the intermediate deformation layer has a stiffness which is variable along a direction parallel to the intermediate deformation layer,
holding the reinforcing substrate and the intermediate deformation layer on the substrate to be reinforced, by means of an adhesive.

19: The method for manufacturing the bonded assembly of claim 16, the method further comprising:
obtaining of data relating to a shape of a surface of the second substrate;
wherein the formation of the intermediate deformation layer is carried out so as to obtain a surface of the intermediate deformation layer having a shape complementary to the shape of the surface of the second substrate.
